(19) United States
(12) Patent Application Publication
(10) Pub. No.: US 2020/0346975 A1
(43) Pub. Date: Nov. 5, 2020

(54) STRENGTHENED GLASS AND MANUFACTURING METHOD THEREFOR

(71) Applicant: Shenzhen Donglihua Technology Co., Ltd., Shenzhen, Guangdong (CN)

(72) Inventors: Wei Hu, Shenzhen, Guangdong (CN); Baoquan Tan, Shenzhen, Guangdong (CN); Fanghua Chen, Shenzhen, Guangdong (CN); Ruijing Chang, Shenzhen, Guangdong (CN)

(21) Appl. No.: 16/761,241

(22) PCT Filed: Jan. 31, 2018
(86) PCT No.: PCT/CN2018/074634

§ 371 Date: May 2, 2020

(30) Foreign Application Priority Data
Nov. 2, 2017 (CN) 201711063615.9

(51) Int. Cl. C03C 21/00; C03C 17/00

(52) U.S. Cl. CPC C03C 21/002; C03C 17/007; C03C 17/008; C03C 2217/48; C03C 2218/355; C03C 2217/475; C03C 2218/328

(57) ABSTRACT

Disclosed are a strengthened glass article and a manufacturing method therefor. The strengthened glass article surface has a surface compressive stress layer formed by an ion exchange method, and the internal tensile stress distributions in different regions of the strengthened glass article are different. The manufacturing method comprises: step S1, coating a partial region of glass to be strengthened with a high temperature-resistant protective coating, and subjecting the protective coating to curing; step S2, placing the glass to be strengthened into a first ion exchange salt bath for chemical strengthening; step S3, taking out the glass to be strengthened from the first ion exchange salt bath, and washing the glass to be strengthened; and step S4, removing the protective coating on the glass to be strengthened. The strengthened glass article not only can ensure that the overall strength meets requirements, but also has sufficient strong safety performance.

### TECHNICAL FIELD

The present disclosure relates generally to a glass manufacture field, and more particularly relates to a strengthened glass and its manufacturing method.

### BACKGROUND

Strengthened glasses have been widely used in the display devices, watches, mobile phones, automobiles and high-speed rails. Generally speaking, the surface compressive stress and internal tensile stress distributions of the same flat strengthened glass are uniform and consistent. Generally, in order to ensure the overall strength and safety of the strengthened glass, it is necessary to ensure that the surface compressive stress of the glass and the overall strength are great enough to meet the use demand, while the internal tensile stress of the glass is controlled not to be too great. When the internal tensile stress is too great, the strengthened glass will explode spontaneously. That is to say, the strengthened glass will crack and break down spontaneously. When the thickness of glass is a certain value, the greater the surface compressive stress of the glass, the greater the internal tensile stress of the glass correspondingly. When the surface compressive stress of the glass is determined, the smaller the thickness of the glass, the greater the internal tensile stress of the glass.

However, for some special requirements, some structural designs are requested. There are special requirements on the glass structures. For example, the thickness of a local region of the glass is smaller than the other regions. After the same glass is strengthened by the same ion exchange procedure, its surface compressive stress is the same, while the internal tensile stress in its thinner region is greater than that in other regions. The thinner region becomes the concentration region of the greater tensile stress. When triggered by an external force, the risk that the thinner region will crack and break down spontaneously is much higher than the other regions. Accordingly, the thinner region becomes an unsafe region.

Nowadays, there are more and more glass designs with uneven thickness.

For example, the curved glass must be used on the surface of the flexible display screen which becomes more and more popular. When this kind of glass is forming the curved surface, it needs to be bended and stretched under a high temperature. The thickness of the curved region is thinner than that of other regions. The strengthened protective glass of the smart phone is integrated with the fingerprint identification module. The fingerprint identification module under the protective glass requests that the medium glass should not have a thickness exceed a certain value; otherwise it cannot sense the fingerprint. Generally, the thickness of the medium glass needs to be controlled to be smaller than 0.25 mm. So the whole protective glass should be designed into a structure with uneven thickness. For example, a blind hole can be arranged at the fingerprint identification module to reduce the thickness of the local glass.

For example, thinner chemically strengthened glasses are more and more used in the electric vehicles, high-speed trains and other means of transportation to replace the thicker physically toughened glass, so as to greatly increase the strength and reduce the thickness. The anti-impact strength of the strengthened glass is usually more than 10 times than that of the physically toughened glass in the same situation, so it is not easy to destroy the glass artificially in case of emergency for coping with the emergency. Although the high anti-impact strength is the biggest characteristic of strengthened glass, however, in the case of emergency, such characteristic has become a disadvantage. Therefore, it is necessary to optimize the existing strengthened glass to not only maintain the anti-impact strength, the safety of the glass, but also make it easy to destroy the glass in the case of emergency.

Generally, in order to ensure the overall safety of the glass with uneven thickness, only the internal tensile stress in the thinner region can be taken as the safety standard. The internal tensile stress in the thinner region of the glass can be reduced by reducing the surface compressive stress of the glass, and the internal tensile stress in other regions of the glass can be reduced for the whole control of the glass.

In such a way, the maximum value of the internal tensile stress of the glass is controlled within the safe range. That is to say, the tensile stress in the tensile stress concentration region is reduced to lower the possibility of spontaneous cracking and breaking down. Meanwhile, the surface compressive stress of the glass is also reduced. The essence of this method is to reduce the surface compressive stress of the glass and sacrifice or reduce the overall strength of the glass, thus ensuring the internal tensile stress in the concentration region of the greater tensile stress would not be too great. The safety of the local region of the glass is protected by sacrificing the overall strength of the glass. The problem of this method is that in order to ensure the safety and avoid the spontaneous explosion, the strength of glass is sacrificed. In such a way, the strength of glass may not meet the requirements of the design and use, or cannot achieve the maximum strength. For this kind of strengthened glass with uneven thickness, its overall strength and safety become a pair of contradictions and dilemmas.

Therefore, it is necessary to design a new strengthened glass and its manufacturing method to overcome the above problems.

### SUMMARY

The object of the present application is to provide a strengthened glass and its manufacturing method which is capable of not only ensuring that the overall strength meets the requirements, but also having sufficient safety performance, aiming at the above problem of the prior art.

According to an aspect, a strengthened glass is provided, which comprising a surface compressive stress layer formed by an ion exchange method on its surface, wherein a distribution of an internal tensile stress in different regions of the strengthened glass are different.

In an embodiment of the present application, an absolute value of a difference between maximum values of the internal tensile stress in different regions of the strengthened glass is smaller than or equal to 368 mpa; wherein the strengthened glass comprises a first surface and a second surface with a spacing of t, and an absolute value of the internal tensile stress between the first surface and the second surface is greater than or equal to 0; wherein a distribution region of the internal tensile stress between the first surface and the second surface is extending from centrals of the first surface and the second surface to the first surface and the second surface for a distance of at least 0.21 t, respectively.

Advantageously, the strengthened glass has a maximum thickness smaller than or equal to 2.2 mm; wherein the surface of the strengthened glass has an ion exchange layer with different depths formed by the ion exchange method, and an absolute value of a difference between the depths of the ion exchange layer in different regions of the surface of the strengthened glass is smaller than or equal to 300 μm.

Advantageously, surface compressive stress values in different regions of the strengthened glass are the same.

Advantageously, an absolute value of a difference between surface compressive stress values in different regions of the strengthened glass is smaller than or equal to 1200 Mpa.

Advantageously, a difference between thicknesses in different regions of the strengthened glass is smaller than 0.04 mm.

Advantageously, the surface compressive stress value of some regions of the strengthened glass is zero.

In a further embodiment of the present application, surface compressive stress values in different regions of the strengthened glass are different.

Advantageously, a difference between thicknesses in different regions of the strengthened glass is greater than or equal to 0.04 mm.

Advantageously, a depth of an ion exchange layer in a region with a smaller thickness of the strengthened glass is smaller than a depth of an ion exchange layer in a region with a greater thickness of the strengthened glass.

In a further aspect, a manufacturing method of a strengthened glass discussed above is provided, which comprising following steps:

step S1, coating a partial region of a glass to be strengthened with a high temperature-resistant protective coating, and subjecting the protective coating to curing;

step S2, placing the glass to be strengthened into a first ion exchange salt bath for a chemical strengthening;

step S3, taking out the glass to be strengthened from the first ion exchange salt bath, and washing the glass to be strengthened; and

step S4, removing the protective coating on the glass to be strengthened;

wherein the protective coating is used to prevent or hinder the partial region of the glass to be strengthened from ion exchanging in the first ion exchange salt bath.

Advantageously, the manufacturing method further comprises following step implemented after the step S4:

step S5, repeating step S1 to step S4 sequentially.

Advantageously, the manufacturing method further comprises following step implemented after the step S4:

step S6, placing the glass to be strengthened into a second ion exchange salt bath for a chemical strengthening.

Advantageously, the manufacturing method of a strengthened glass further comprises following step implemented after the step S3 and before the step S4:

Step S7, repeating step S2 to step S3 sequentially.

Advantageously, a curing temperature of the protective coating is lower than a softening point temperature of the glass to be strengthened.

Advantageously, the protective coating does not contain an alkali metal component.

Compared with the prior art, the present application has the following beneficial effects. As different regions of the surface of the strengthened glass have ion exchange layer with different depths formed by the ion exchange method, the strengthened glass can ensure that not only its overall strength meets the requirements, but also its safety performance is sufficiently strong.

### DETAILED DESCRIPTION OF THE PREFERRED EMBODIMENT

To make the object, the technical solution, and the advantage of the present application more clearly, the present application is further described in detail below with reference to the accompanying embodiments. Obviously, the described embodiments are only part of the embodiments of the present application, not all of them. Based on the embodiments in the present application, all other embodiments obtained by one skilled in the art without creative work belong to the protection scope of the present application.

The manufacturing method of a strengthened glass in the present application mainly comprises following steps:

step S1, coating a partial region of a glass to be strengthened with a high temperature-resistant protective coating, and subjecting the protective coating to curing;

step S2, placing the glass to be strengthened into a first ion exchange salt bath for a chemical strengthening;

step S3, taking out the glass to be strengthened from the first ion exchange salt bath, and washing the glass to be strengthened; and

step S4, removing the protective coating on the glass to be strengthened.

The protective coating used in step S1 can prevent or hinder the partial region of the glass to be strengthened from ion exchanging in the first ion exchange salt bath. Accordingly, after the treatment of the above steps, the depth of the ion exchange layer of the partial region of the glass to be strengthened must be smaller than the depth of the ion exchange layer of the other region of the glass to be strengthened.

That is to say, after the glass to be strengthened is treated by the manufacturing method of a strengthened glass provided by the present application, the strengthened glass having ion exchange layers of different depths formed by the ion exchange method on different regions of its surface, can be obtained.

When multiple times of ion exchange should be carried out on the glass to be strengthened according to the parameter requirements on the surface compressive stress of the final obtained strengthened glass for the specific application scenarios; step S5 in which repeating step S1 to step S4 sequentially can be added after step S4, or step S7 in which repeating step S2 to step S3 sequentially can be added after step S3, but before Step S4. When the specific application scenario requires that the final obtained strengthened glass should have the same surface compressive stress, the step S6 in which placing the glass to be strengthened into a second ion exchange salt bath for a chemical strengthening, can be added after step S4 or step S5.

The specific embodiments are listed below for a more detailed description of the present application, but the protection scope of the present application is not limited in any way.

### Embodiment 1

A plate-shaped glass to be strengthened with a blind hole at the center is prepared. The thickness of the glass to be strengthened at the region of the blind hole is 2.1 mm, while the thickness of the glass to be strengthened at other region is basically 2.2 mm (the error is smaller than 0.04 mm).

Then the glass to be strengthened is treated as follows.

In step S1, both side surfaces of the blind hole and the region around the blind hole within 5 mm is coated with the protective coating a which covers the whole blind hole and the region around the blind hole within 5 mm. Moreover, the protective coating a on the inner side of the front surface of the blind hole has a thickness about 35-40 μm, while the protective coating a on the back surface of the blind hole has a thickness about 15-20 μm. Then the protective coating is cured under a certain condition.

In step S2, the glass to be strengthened is placed into the ion exchange salt bath a of 420° C. to going through a chemical strengthening for 120 minutes.

In step S3, the glass to be strengthened is taken out and washed.

In step S4, the glass to be strengthened is placed into the film fading solution a for removing the protective coating a on the glass to be strengthened.

Finally, the strengthened glass is obtained.

Among them, the glass to be strengthened is GLKAILLY™6 provided by SHENZHEN DONGLIHUA TECHNOLOGY CO., LTD.

The protective coating a is a high temperature-resistant protective coating obtained by adequately mixing inorganic particles, glass 8205 powder and organic solvent according to the mass ratio of 5:2:4.

The inorganic particles are a mixture obtained by mixing alumina and calcium carbonate at the mass ratio of 7:3 and the maximum particle size of the inorganic particle is between 2-10 μm.

The preparation process of the glass 8205 powder is as follows.

(1) The raw materials of each mass proportion are weighed according to the content formula in the table listed below, then mixed and stirred uniformly.

| Raw | | | | | | | | | |
|---|---|---|---|---|---|---|---|---|---|
| material | Bi₂O₃ | ZnO | TiO₂ | ZrO₂ | Al₂O₃ | MgO | K₂O | Na₂O | SiO₂ |
| Mass | 3.8 | 5.5 | 1.9 | 2.4 | 15 | 5 | 8 | 15 | 43.4 |
| ratio (%) | | | | | | | | | |

(2) The mixture is placed into the crucible and heated to over 1300° C. for melting the glass.

(3) The molten glass is introduced to water for quenching. In such a way, the smaller glass particles are obtained.

(4) The glass particles obtained in the firing process are put into the air flow grinder for crushing.

(5) The glass particles with a particle size less than 100 μm are selected.

(6) After mixing with water (the mass ratio is: Glass:water:aqueous solvent (such as ethanol)=50:25:25, glass:water=50:50), the mixture is further ground and comminuted in the bead mill until its maximum particle size is smaller than 50 μm. After that the aqueous solution containing glass is obtained.

(7) The water solution containing glass is heated to evaporate the water completely for to obtaining the glass 8205 powder.

The preparation process of the organic solvent is as follows.

160 g of C₅ modified petroleum resin is added into 340 g of solvent terpineol and stirred adequately. 2.4% ethyl cellulose N-50 is further added as a filler and stirred adequately. After that, 3% winsperse3090 is further added and stirred adequately. Then 3% lacquer non-silicon defoamer (SER2035A) is added and stirred adequately. Finally 8% JL-156 (titanate coupling agent) is added and stirred adequately to obtain the organic solvent solution.

Curing conditions of the protective coating a is that heating for 10 minutes at 370° C.

The ion exchange salt bath a is a mixed molten solution of KNO₃/NaNO₃ (100%˜70% NaNO₃).

The formula of the film fading solution a comprise 15 wt % inorganic base of KOH, 10 wt % sodium dodecylbenzene sulfonate, 7 wt % diethanolamine, 5 wt % triethylamine, 63 wt % deionized water as the solvent.

In this embodiment, the surface compressive stress, internal tensile stress and ion exchange depth of the blind hole region and other region of the finally obtained strengthened glass are also detected by the common detection method in the industry, and the detection results are shown in Table 1.

TABLE 1

| | Detection item | | |
|---|---|---|---|
| | Surface | Internal | Ion |
| | compressive | tensile | exchange |
| Detection regions | stress | stress | depth |
| Blind hole region | 350.3 MPa | 32.2 MPa | 170.7 μm |
| Other region | 550.6 MPa | 70.2 MPa | 223.5 μm |

The detection results show that, as the blind hole region is coated with the protective coating a, the final surface compressive stress in the blind hole region of the strengthened glass is different from that in the other region, and the difference between the surface compressive stress value of the blind hole region and that of other region is 200.3 Mpa (which is smaller than 1200 Mpa). The difference between the internal tensile stress in the blind hole region on the surface of the strengthened glass and that in the other region is 38.0 Mpa. The difference between the depth of the ion exchange layer in the blind hole region on the surface of the strengthened glass and that in the other region is 52.8 μm. The distribution range of the internal tensile stress in the blind hole region of the final strengthened glass is extending from the center of the blind hole region to the front surface and back surface of the blind hole region for 0.42*2.1 mm respectively, while the distribution range of the internal tensile stress in the other region is extending from the center of the other region to the front surface and back surface of the other region for 0.40*2.2 mm, respectively.

### Embodiment 2

The difference of the present embodiment from embodiment 1 is only as follows.

Firstly, in step S2, the glass to be strengthened is placed into an ion-exchange salt bath a at 430° C. for 180 minutes.

In addition, the protective coating b is used instead of the protective coating a. In this embodiment, the difference between the protective coating b and the protective coating a is that the glass 8206 powder is used instead of the glass 8205 powder, wherein the preparation process of the glass 8206 powder is as follows.

(1) The raw materials of each mass proportion are weighed according to the content formula in the table listed below, then mixed and stirred uniformly.

| Raw material | B₂O₃ | ZnO | TiO₂ | ZrO₂ | Al₂O₃ | MgO | SiO₂ |
|---|---|---|---|---|---|---|---|
| Mass ratio (%) | 3.7 | 4.5 | 2.3 | 3.5 | 11 | 10 | 65 |

(2) The mixture is placed into the crucible and heated to over 1300° C. for melting the glass.

(3) The molten glass is introduced to water for quenching. In such a way, the smaller glass particles are obtained.

(4) The glass particles obtained in the firing process are put into the air flow grinder for crushing.

(5) The glass particles with a particle size less than 100 μm are selected.

(6) After mixing with water (the mass ratio is: glass:water:aqueous solvent (such as ethanol)=50:25:25, glass:water=50:50), the mixture is further ground and comminuted in the bead mill until its maximum particle size is smaller than 50 μm. After that the aqueous solution containing glass is obtained.

(7) The water solution containing glass is heated to evaporate the water completely for to obtaining the glass 8206 powder.

Similarly, in this embodiment, the surface compressive stress, internal tensile stress and ion exchange depth of the blind hole region and other region of the finally obtained strengthened glass are also detected by the common detection method in the industry, and the detection results are shown in Table 2. The blind hole region is the region coated with the protective coating b, and the other region are the regions not coated with the protective coating b.

TABLE 2

| | Detection item | | |
|---|---|---|---|
| | Surface | Internal | Ion |
| | compressive | tensile | exchange |
| Detection regions | stress | stress | depth |
| Blind hole region | 0.0 MPa | 0.0 MPa | 0.0 μm |
| Other region | 457.4 MPa | 85.8 MPa | 300 μm |

The detection results show that, the final surface compressive stress in the blind hole region of the strengthened glass is different from that in the other region, and the difference between the surface compressive stress value of the blind hole region and that of other region is 457.4 Mpa (which is smaller than 1200 Mpa). The depth of the ion exchange layer in the blind hole region on the surface of the strengthened glass is zero, and the surface compressive stress in the blind hole region of the strengthened glass is also zero. In additional, the difference between the internal tensile stress in the blind hole region on the surface of the strengthened glass and that in the other region is 85.8 Mpa. The difference between the depth of the ion exchange layer in the blind hole region on the surface of the strengthened glass and that in the other region is 300 μm. The distribution range of the internal tensile stress in the blind hole region of the final strengthened glass is extending from the center of the blind hole region to the front surface and back surface of the blind hole region for 0 mm respectively, while the distribution range of the internal tensile stress in the other region is extending from the center of the other region to the front surface and back surface of the other region for 0.36*2.2 mm respectively.

### Embodiment 3

The difference of the present embodiment from embodiment 1 is only as follows.

Firstly, in step S2, the glass to be strengthened is placed into an ion-exchange salt bath a at 400° C. for 25 minutes.

Secondly, the protective coating b is used instead of the protective coating a.

In addition, Step S5 is added after the step S4, in which step S5, the step S1-S4 are repeated sequentially.

Similarly, in this embodiment, the surface compressive stress, internal tensile stress and ion exchange depth of the blind hole region and other region of the finally obtained strengthened glass are also detected by the common detection method in the industry, and the detection results are shown in Table 3.

TABLE 3

| | Detection item | | |
|---|---|---|---|
| | Surface | Internal | Ion |
| | compressive | tensile | exchange |
| Detection regions | stress | stress | depth |
| Blind hole region | 0.0 Mpa | 0.0 Mpa | 0.0 μm |
| Other region | 1200.0 Mpa | 14.0 MPa | 25.1 μm |

The detection results show that, the final surface compressive stress in the blind hole region of the strengthened glass is different from that in the other region, and the difference between the surface compressive stress value of the blind hole region and that of the other region is equal to 1200 Mpa. The difference between the internal tensile stress in the blind hole region on the surface of the strengthened glass and that in the other region is 14.0 Mpa. The difference between the depth of the ion exchange layer in the blind hole region and that in the other region is 25.1 μm. The distribution range of the internal tensile stress in the blind hole region of the final strengthened glass is extending from the center of the blind hole region to the front surface and back surface of the blind hole region for 0.50*2.1 mm respectively, while the distribution range of the internal tensile stress in the other region is extending from the center of the other region to the front surface and back surface of the other region for 0.49*2.2 mm respectively.

### Embodiment 4

The difference of the present embodiment from embodiment 1 is only as follows.

Firstly, the thickness of the blind hole region of the glass to be strengthened is 0.3 mm, and the thickness of other region of the glass to be strengthened is basically 0.65 mm (the error is smaller than 0.04 mm); in step S2, the glass to be strengthened is placed into an ion-exchange salt bath a at 420° C. for 110 minutes.

Secondly, the protective coating b is used instead of the protective coating a.

In addition, Step S7 is added after the step S3 but before step S4, in which step S7, the step S2-S3 are repeated sequentially.

Similarly, in this embodiment, the surface compressive stress, internal tensile stress and ion exchange depth of the blind hole region and other region of the finally obtained strengthened glass are also detected by the common detection method in the industry, and the detection results are shown in Table 4.

TABLE 4

| | Detection item | | |
|---|---|---|---|
| | Surface | Internal | Ion |
| | compressive | tensile | exchange |
| Detection regions | stress | stress | depth |
| Blind hole region | 0.0 MPa | 0.0 MPa | 0.0 μm |
| Other region | 702.8 MPa | 368.0 MPa | 189.3 μm |

The detection results show that, the final surface compressive stress in the blind hole region of the strengthened glass is different from that in the other region, and the difference between the surface compressive stress value of the blind hole region and that of other region is 702.8 Mpa. In additional, the difference between the internal tensile stress in the blind hole region on the surface of the final strengthened glass and that in the other region is 368.0 Mpa. The difference between the depth of the ion exchange layer in the blind hole region on the surface of the final strengthened glass and that in the other region is 189.3 μm. The distribution range of the internal tensile stress in the blind hole region of the final strengthened glass is extending from the center of the blind hole region to the front surface and back surface of the blind hole region for 0 mm respectively, while the distribution range of the internal tensile stress in the other region is extending from the center of the other region to the front surface and back surface of the other region for 0.21*0.65 mm respectively.

### Embodiment 5

The difference of the present embodiment from embodiment 3 is only as follows.

Firstly, the thickness of the blind hole region of the glass to be strengthened is 0.3 mm, and the thickness of other region of the glass to be strengthened is basically 0.65 mm (the error is smaller than 0.04 mm); the step S6 is added after the step S5, in which the glass to be strengthened is placed into an ion-exchange salt bath b at 390° C. for 25 minutes, then is taken out and washed.

Secondly, the protective coating b is used instead of the protective coating a.

The composition of the ion exchange salt bath b is a mixed molten solution of KNO₃/NaNO₃ (0%˜10% NaNO₃).

Similarly, in this embodiment, the surface compressive stress, internal tensile stress and ion exchange depth of the blind hole region and other region of the finally obtained strengthened glass are also detected by the common detection method in the industry, and the detection results are shown in Table 5.

TABLE 5

| | Detection item | | |
|---|---|---|---|
| | Surface | Internal | Ion |
| | compressive | tensile | exchange |
| Detection regions | stress | stress | depth |
| Blind hole region | 952.2 MPa | 53.7 MPa | 15.2 μm |
| Other region | 952.2 MPa | 72.0 MPa | 154.8 μm |

The detection results show that, the final surface compressive stress in the blind hole region on the surface of the strengthened glass is same as that in the other region. The strengthened glass with uniform surface compressive stress and uneven thickness is obtained. In additional, the difference between the internal tensile stress in the blind hole region on the surface of the strengthened glass and that in the other region is 18.3 Mpa. The difference between the depth of the ion exchange layer in the blind hole region on the surface of the strengthened glass and that in the other region is 139.6 μm. The difference between the depth of the ion exchange layer in the blind hole region on the surface of the strengthened glass and that in the other region is 183.9 μm. The distribution range of the internal tensile stress in the blind hole region of the final strengthened glass is extending from the center of the blind hole region to the front surface and back surface of the blind hole region for 0.45*0.3 mm respectively, while the distribution range of the internal tensile stress in the other region is extending from the center of the other region to the front surface and back surface of the other region for 0.26*0.65 mm respectively.

### Embodiment 6

The difference of the present embodiment from embodiment 4 is only as follows.

Firstly, the thickness of the blind hole region of the glass to be strengthened is 0.2 mm, and the thickness of other region of the glass to be strengthened is basically 0.65 mm (the error is smaller than 0.04 mm); the step S6 is added after the step S4, in which the glass to be strengthened is placed into an ion-exchange salt bath b at 390° C. for 25 minutes, then is taken out and washed.

Secondly, the protective coating b is used instead of the protective coating a.

Similarly, in this embodiment, the surface compressive stress, internal tensile stress and ion exchange depth of the blind hole region and other region of the finally obtained strengthened glass are also detected by the common detection method in the industry, and the detection results are shown in Table 6.

TABLE 6

| | Detection item | | |
|---|---|---|---|
| | Surface | Internal | Ion |
| | compressive | tensile | exchange |
| Detection regions | stress | stress | depth |
| Blind hole region | 955.4 MPa | 53.9 MPa | 15.2 μm |
| Other region | 955.4 MPa | 62.0 MPa | 120.8 μm |

The detection results show that, the final surface compressive stress in the blind hole region of the strengthened glass is same as that of the other region. In additional, the difference between the internal tensile stress in the blind hole region on the surface of the strengthened glass and that in the other region is 8.1 Mpa. The difference between the depth of the ion exchange layer in the blind hole region on the surface of the strengthened glass and that in the other region is 105.6 μm. The distribution range of the internal tensile stress in the blind hole region of the final strengthened glass is extending from the center of the blind hole region to the front surface and back surface of the blind hole region for 0.42*0.2 mm respectively, while the distribution range of the internal tensile stress in the other region is extending from the center of the other region to the front surface and back surface of the other region for 0.31*0.65 mm respectively.

### Embodiment 7

At first, a plate-shaped glass to be strengthened with a uniform thickness is prepared. The thickness of the glass to be strengthened is 2.2 mm.

Then the glass to be strengthened is treated as follows.

In step S1, both surfaces of the central of the strengthened glass is coated with the protective coating a with a thickness about 15-20 μm. Then the protective coating is cured under a certain condition.

In step S2, the glass to be strengthened is placed into the ion exchange salt bath a of 420° C. to going through a chemical strengthening for 120 minutes.

In step S3, the glass to be strengthened is taken out and washed.

In step S4, the glass to be strengthened is placed into the film fading solution a for removing the protective coating a on the glass to be strengthened.

Finally, the strengthened glass is obtained.

In this embodiment, the surface compressive stress, internal tensile stress and ion exchange depth of the coating coverage region and the exposed region of the finally obtained strengthened glass are also detected by the common detection method in the industry, and the detection results are shown in Table 7. The coating coverage region is the region coated with the protective coating a, and the exposed region is the region not coated with the protective coating a.

TABLE 7

| | Detection item | | |
|---|---|---|---|
| | Surface | Internal | Ion |
| | compressive | tensile | exchange |
| Detection regions | stress | stress | depth |
| Coating coverage | 347.7 MPa | 32.1 MPa | 155.9 μm |
| region | | | |
| Exposed region | 540.3 MPa | 63.0 MPa | 213.4 μm |

The detection results show that, the final surface compressive stress of the coating coverage region of the strengthened glass is different from that of the exposed region, and the difference between the surface compressive stress value of the coating coverage region and that of exposed region is 192.6 Mpa. In additional, the difference between the internal tensile stress in the coating coverage region on the surface of the strengthened glass and that in exposed region is 30.9 Mpa. The difference between the depth of the ion exchange layer in the coating coverage region on the surface of the strengthened glass and that in exposed region is 57.5 μm. The distribution range of the internal tensile stress in the coating coverage region of the final strengthened glass is extending from the center of the coating coverage region to the front surface and back surface of the coating coverage region for 0.42*2.0 mm respectively, while the distribution range of the internal tensile stress in the exposed region is extending from the center of the exposed region to the front surface and back surface of the other region for 0.39*2.0 mm respectively.

### Embodiment 8

The difference of the present embodiment from embodiment 7 is only as follows

At first, a plate-shaped glass to be strengthened with a uniform thickness is prepared. The thickness of the glass to be strengthened is 2.2 mm and in step S2, the glass to be strengthened is placed into an ion-exchange salt bath a at 450° C. for 180 minutes.

In addition, the protective coating b is used instead of the protective coating a.

Similarly, in this embodiment, the surface compressive stress, internal tensile stress and ion exchange depth of the coating coverage region and the exposed region of the finally obtained strengthened glass are also detected by the common detection method in the industry, and the detection results are shown in Table 8. The coating coverage region is the region coated with the protective coating b, and the exposed region is the region not coated with the protective coating b.

TABLE 8

| | Detection item | | |
|---|---|---|---|
| | Surface | Internal | Ion |
| | compressive | tensile | exchange |
| Detection regions | stress | stress | depth |
| Coating coverage | 0.0 Mpa | 0.0 Mpa | 0.0 μm |
| region | | | |
| Exposed region | 410.1 Mpa | 87.9 Mpa | 300.0 μm |

The detection results show that, the final surface compressive stress of the coating coverage region of the strengthened glass is different from that of the exposed region, and the difference between the surface compressive stress value of the coating coverage region and that of exposed region is 410.1 Mpa. In additional, the difference between the internal tensile stress in the coating coverage region on the surface of the strengthened glass and that in exposed region is 87.9 Mpa. The difference between the depth of the ion exchange layer in the coating coverage region on the surface of the strengthened glass and that in exposed region is 300 μm. The distribution range of the internal tensile stress in the coating coverage region of the final strengthened glass is extending from the center of the coating coverage region to the front surface and back surface of the coating coverage region for 0 mm respectively, while the distribution range of the internal tensile stress in the exposed region is extending from the center of the exposed region to the front surface and back surface of the other region for 0.36*2.2 mm respectively.

### Embodiment 9

The difference of the present embodiment from embodiment 7 is only as follows

At first, in step S2, the glass to be strengthened is placed into an ion-exchange salt bath a at 400° C. for 25 minutes.

Secondly, the protective coating b is used instead of the protective coating a.

In addition, Step S5 is added after the step S4, in which step S5, the step S1-S4 are repeated sequentially. Furthermore, the step S5 has been repeated for 5 times.

Similarly, in this embodiment, the surface compressive stress, internal tensile stress and ion exchange depth of the coating coverage region and the exposed region of the finally obtained strengthened glass are also detected by the common detection method in the industry, and the detection results are shown in Table 9. The coating coverage region is the region coated with the protective coating b, and the exposed region is the region not coated with the protective coating b.

TABLE 9

| | Detection item | | |
|---|---|---|---|
| | Surface | Internal | Ion |
| | compressive | tensile | exchange |
| Detection regions | stress | stress | depth |
| Coating coverage | 0.0 MPa | 0.0 MPa | 0.0 μm |
| region | | | |
| Exposed region | 1200.0 MPa | 14.9 MPa | 24.2 μm |

The detection results show that, the final surface compressive stress of the coating coverage region of the strengthened glass is different from that of the exposed region, and the difference between the surface compressive stress value of the coating coverage region and that of exposed region is equal to 1200 Mpa. In additional, the difference between the internal tensile stress in the coating coverage region on the surface of the strengthened glass and that in exposed region is 14.9 Mpa. The difference between the depth of the ion exchange layer in the coating coverage region on the surface of the strengthened glass and that in exposed region is 24.2 μm. The distribution range of the internal tensile stress in the coating coverage region of the final strengthened glass is extending from the center of the coating coverage region to the front surface and back surface of the coating coverage region for 0 mm respectively, while the distribution range of the internal tensile stress in the exposed region is extending from the center of the exposed region to the front surface and back surface of the other region for 0.49*2.0 mm respectively.

### Embodiment 10

The difference of the present embodiment from embodiment 7 is only as follows

At first, a plate-shaped glass to be strengthened with a uniform thickness is prepared. The thickness of the glass to be strengthened is 0.65 mm and in step S2, the glass to be strengthened is placed into an ion-exchange salt bath a at 420° C. for 110 minutes.

Secondly, the protective coating b is used instead of the protective coating a.

In addition, the step S7 is added between the step S3 and step S4, in which step S7, the step S2-step S3 are repeated sequentially.

Similarly, in this embodiment, the surface compressive stress, internal tensile stress and ion exchange depth of the coating coverage region and the exposed region of the finally obtained strengthened glass are also detected by the common detection method in the industry, and the detection results are shown in Table 10. The coating coverage region is the region coated with the protective coating b, and the exposed region is the region not coated with the protective coating b.

TABLE 10

| | Detection item | | |
|---|---|---|---|
| | Surface | Internal | Ion |
| | compressive | tensile | exchange |
| Detection regions | stress | stress | depth |
| Coating coverage | 0.0 MPa | 0.0 MPa | 0.0 μm |
| region | | | |
| Exposed region | 720.0 MPa | 368.0 MPa | 185.3 μm |

The detection results show that, the final surface compressive stress of the coating coverage region of the strengthened glass is different from that of the exposed region, and the difference between the surface compressive stress value of the coating coverage region and that of exposed region is equal to 720.0 Mpa. In additional, the difference between the internal tensile stress in the coating coverage region on the surface of the strengthened glass and that in exposed region is 368.0 Mpa. The difference between the depth of the ion exchange layer in the coating coverage region on the surface of the strengthened glass and that in exposed region is 185.3 μm. The distribution range of the internal tensile stress in the coating coverage region of the final strengthened glass is extending from the center of the coating coverage region to the front surface and back surface of the coating coverage region for 0 mm respectively, while the distribution range of the internal tensile stress in the exposed region is extending from the center of the exposed region to the front surface and back surface of the other region for 0.21*0.65 mm, respectively.

### Embodiment 11

The difference of the present embodiment from embodiment 9 is only as follows

At first, a plate-shaped glass to be strengthened with a uniform thickness is prepared. The thickness of the glass to be strengthened is 0.7 mm and the step S6 is added after the step S5, in which the glass to be strengthened is placed into an ion-exchange salt bath b at 390° C. for 25 minutes, then is taken out and washed.

Secondly, the protective coating b is used instead of the protective coating a.

Similarly, in this embodiment, the surface compressive stress, internal tensile stress and ion exchange depth of the coating coverage region and the exposed region of the finally obtained strengthened glass are also detected by the common detection method in the industry, and the detection results are shown in Table 11. The coating coverage region is the region coated with the protective coating b, and the exposed region is the region not coated with the protective coating b.

TABLE 11

| | Detection item | | |
|---|---|---|---|
| | Surface | Internal | Ion |
| | compressive | tensile | exchange |
| Detection regions | stress | stress | depth |
| Coating coverage | 851.4 MPa | 20.0 MPa | 15.7 μm |
| region | | | |
| Exposed region | 851.4 MPa | 68.0 MPa | 152.4 μm |

The detection results show that, the final surface compressive stress of the coating coverage region of the strengthened glass is same as that of the exposed region. In additional, the difference between the internal tensile stress in the coating coverage region on the surface of the strengthened glass and that in exposed region is 48.0 Mpa. The difference between the depth of the ion exchange layer in the coating coverage region on the surface of the strengthened glass and that in exposed region is 136.7 μm. The distribution range of the internal tensile stress in the coating coverage region of the final strengthened glass is extending from the center of the coating coverage region to the front surface and back surface of the coating coverage region for 0.48*0.7 mm respectively, while the distribution range of the internal tensile stress in the exposed region is extending from the center of the exposed region to the front surface and back surface of the other region for 0.28*0.7 mm respectively.

### Embodiment 12

The difference of the present embodiment from embodiment 10 is only as follows

At first, a plate-shaped glass to be strengthened with a uniform thickness is prepared. The thickness of the glass to be strengthened is 0.7 mm and the step S6 is added after the step S4, in which the glass to be strengthened is placed into an ion-exchange salt bath b at 390° C. for 25 minutes, then is taken out and washed.

Secondly, the protective coating b is used instead of the protective coating a.

Similarly, in this embodiment, the surface compressive stress, internal tensile stress and ion exchange depth of the coating coverage region and the exposed region of the finally obtained strengthened glass are also detected by the common detection method in the industry, and the detection results are shown in Table 12. The coating coverage region is the region coated with the protective coating b, and the exposed region is the region not coated with the protective coating b.

TABLE 12

| | Detection item | | |
|---|---|---|---|
| | Surface | Internal | Ion |
| | compressive | tensile | exchange |
| Detection regions | stress | stress | depth |
| Coating coverage | 0.0 MPa | 0.0 MPa | 0.0 μm |
| region | | | |
| Exposed region | 680.2 MPa | 72.3 MPa | 180.3 μm |

The detection results show that, the surface compressive stress, internal tensile stress and ion exchange depth of the coating coverage region of the finally obtained strengthened glass are all zero. In additional, the difference between the surface compressive stress value in the coating coverage region and that in the exposed region is 680.2 Mpa. In additional, the difference between the internal tensile stress in the coating coverage region on the surface of the strengthened glass and that in exposed region is 72.3 Mpa. The difference between the depth of the ion exchange layer in the coating coverage region on the surface of the strengthened glass and that in exposed region is 180.3 μm. The distribution range of the internal tensile stress in the coating coverage region of the final strengthened glass is extending from the center of the coating coverage region to the front surface and back surface of the coating coverage region for 0 mm respectively, while the distribution range of the internal tensile stress in the exposed region is extending from the center of the exposed region to the front surface and back surface of the other region for 0.24*0.7 mm respectively.

The foregoing is a further detailed description of the present application in connection with specific preferred embodiments, and cannot be considered as that the specific implementation of the present application is limited to these illustrations. It will be apparent to those skilled in the art that any various modifications or substitutions may be made to the present application without departing from the spirit of the invention, and such modifications or substitutions should be considered as falling within the scope of the present application.

1. A strengthened glass comprising a first surface and a second surface with a spacing of t; wherein a difference between thicknesses in different regions of the strengthened glass is greater than or equal to 0.04 mm; the strengthened glass comprises a surface compressive stress layer formed by an ion exchange method on its surface, wherein a distribution of an internal tensile stress in different regions of the strengthened glass are different; an absolute value of a difference between maximum values of the internal tensile stress in different regions of the strengthened glass is smaller than or equal to 368 MPa.

2. The strengthened glass according to claim 1, wherein an absolute value of the internal tensile stress between the first surface and the second surface is greater than or equal to 0; wherein a distribution region of the internal tensile stress between the first surface and the second surface is extending from centrals of the first surface and the second surface to the first surface and the second surface for a distance of at least 0.21 t, respectively.

3. The strengthened glass according to claim 1, wherein the strengthened glass has a maximum thickness smaller than or equal to 2.2 mm; wherein the surface of the strengthened glass has an ion exchange layer with different depths formed by the ion exchange method, and an absolute value of a difference between the depths of the ion exchange layer in different regions of the surface of the strengthened glass is smaller than or equal to 300 μm.

4. The strengthened glass according to claim 1, wherein surface compressive stress values in different regions of the strengthened glass are the same.

5. The strengthened glass according to claim 1, wherein surface compressive stress values in different regions of the strengthened glass are different.

6. The strengthened glass according to claim 5, wherein an absolute value of a difference between surface compressive stress values in different regions of the strengthened glass is smaller than or equal to 1200 MPa.

7. The strengthened glass according to claim 5, wherein the surface compressive stress value of some regions of the strengthened glass is zero.

8. (canceled)

9. (canceled)

10. The strengthened glass according to claim 1, wherein a depth of an ion exchange layer in a region with a smaller thickness of the strengthened glass is smaller than a depth of an ion exchange layer in a region with a greater thickness of the strengthened glass.

11. A manufacturing method of a strengthened glass, comprising following steps:
step S1, coating a partial region of a glass to be strengthened with a high temperature-resistant protective coating, and subjecting the protective coating to curing;
step S2, placing the glass to be strengthened into a first ion exchange salt bath for an ion exchange;
step S3, taking out the glass to be strengthened from the first ion exchange salt bath, and washing the glass to be strengthened; and
step S4, removing the protective coating on the glass to be strengthened;
wherein the protective coating is used to prevent or hinder the partial region of the glass to be strengthened from ion exchanging in the first ion exchange salt bath;
wherein the strengthened glass comprises a first surface and a second surface with a spacing of t; a difference between thicknesses in different regions of the strengthened glass is greater than or equal to 0.04 mm; wherein the strengthened glass comprises a surface compressive stress layer formed by an ion exchange method on its surface, wherein a distribution of an internal tensile stress in different regions of the strengthened glass are different; an absolute value of a difference between maximum values of the internal tensile stress in different regions of the strengthened glass is smaller than or equal to 368 MPa.

12. The manufacturing method according to claim 11, wherein further comprises following step implemented after the step S4:
step S5, repeating step S1 to step S4 sequentially.

13. The manufacturing method according to claim 11, wherein further comprises following step implemented after the step S4:
step S6, placing the glass to be strengthened into a second ion exchange salt bath for a chemical strengthening.

14. The manufacturing method according to claim 11, wherein further comprises following step implemented after the step S4:
Step S7, repeating step S2 to step S3 sequentially.

15. The manufacturing method according to claim 11, wherein a curing temperature of the protective coating is lower than a softening point temperature of the glass to be strengthened.

16. The manufacturing method according to claim 11, wherein the protective coating is a high temperature-resistant protective coating obtained by adequately mixing inorganic particles, glass 8205 powder and organic solvent according to the mass ratio of 5:2:4.

17. The manufacturing method according to claim 11, wherein the protective coating is a high temperature-resistant protective coating obtained by adequately mixing inorganic particles, glass 8206 powder and organic solvent according to the mass ratio of 5:2:4.

18. The manufacturing method according to claim 16, wherein the inorganic particles are a mixture obtained by mixing alumina and calcium carbonate at the mass ratio of 7:3°

19. The manufacturing method according to claim 17, wherein a maximum particle size of the inorganic particle is between 2-10 μm.

20. The manufacturing method according to claim 11, wherein the first ion exchange salt bath is a mixed molten solution of KNO₃/NaNO₃ which containing 100%˜70% NaNO₃.

21. The manufacturing method according to claim 13, wherein the second ion exchange salt bath is a mixed molten solution of KNO₃/NaNO₃ which containing 0%˜10% NaNO₃.

22. The manufacturing method according to claim 11, wherein in the step S4, the protective coating is removed by a film fading solution comprise 15 wt % inorganic base of KOH, 10 wt % sodium dodecylbenzene sulfonate, 7 wt % diethanolamine, 5 wt % triethylamine, 63 wt % deionized water as the solvent.
